(19) United States
(12) Patent Application Publication
(10) Pub. No.: US 2005/0258171 A1
(43) Pub. Date: Nov. 24, 2005

(54) Microwave oven with infrared heat

(75) Inventor: Allan E. Witt, Milwaukee, WI (US)

Correspondence Address: FOLEY & LARDNER, 777 EAST WISCONSIN AVENUE, SUITE 3800, MILWAUKEE, WI, 53202-5308, US

(73) Assignee: Hatco Corporation

(21) Appl. No.: 10/842,398

(22) Filed: May 10, 2004

(51) Int. Cl. H05B 6/64

(52) U.S. Cl. 219/685

(57) ABSTRACT

A microwave oven device for heating at least one food item is disclosed. The oven device comprises an oven housing defining a heating cavity. The heating cavity receives the at least one food item to be heated by the oven device. The oven device also comprises a microwave energy source for heating the at least one food item with microwave energy. Further, the oven device comprises a heating unit disposed within the oven housing the heating unit comprising a heating element. The heating element generates radiant heat which is directed toward the at least one food item received in the heating cavity. The heating element comprises a rapidly-heating, high-intensity resistive ribbon heating element capable of being cycled on for final finishing of the at least one food item when the at least one food item is received in the heating cavity, and capable of being cycled off when such final finishing is not being performed, the resistive ribbon heating element configured to provide radiant energy directly to the food item.

### BACKGROUND OF THE INVENTION

The present invention relates generally to the field of microwave ovens. The present invention more specifically relates to microwave ovens having a source of infrared heat.

Conventional microwave ovens heat food by providing microwave energy in the form of microwave radiation to food items. The application of microwave energy to a food item often breaks down the structure of the food item and produces a soggy or chewy consistency. Further, heating food with microwave energy does not produce a food item with a crusty or browned top which may be produced, and is often desirable in a conventional oven.

Accordingly, there is a need for a microwave device which includes a heating element that provides browning and/or final finishing of a food item that is disposed within the microwave oven device.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the aforementioned needs.

### SUMMARY

An example of the invention relates to a microwave oven device for heating at least one food item. The oven device comprises an oven housing defining a heating cavity therein. The heating cavity receives the at least one food item to be heated by the oven device. A microwave energy source for heating the at least one food item with microwave energy is also included. A heating unit is disposed within the oven housing. The heating unit comprises a heating element. The heating unit generates radiant heat which is directed to the at least one food item received in the heating cavity. The heating element comprises a rapidly-heating, high-intensity resistive ribbon heating element capable of being cycled on for final finishing of the at least one food item when the at least one food item is received in the heating cavity. The heating unit is capable of being cycled off when such final finishing is not being performed. The resistive ribbon heating element is configured to provide radiant energy directly to the food item.

Another example of the invention relates to a microwave oven device for cooking a food item. The microwave oven device comprises a heating cavity configured to receive the food item. The microwave oven device also comprises a microwave unit configured to provide microwave energy to the food item. Further, the microwave oven device comprises a heating unit, the heating unit comprising a heating element. The heating unit generates radiant heat which is directed onto the food item when the food item is received in the heating cavity. The heating element comprises a rapidly-heating high-intensity resistive ribbon heating element. The resistive heating element provides radiant energy directly to the food item.

Yet another example of the invention relates to a microwave oven for cooking a food item. The microwave oven comprises an oven housing means for defining a heating cavity for receiving the food item. The microwave oven also comprises a means for providing microwave energy to the food item. Further, the microwave oven comprises a resistive ribbon heating means within the oven housing means for generating high-intensity radiant heat and for directing the heat directly onto a top surface of the food item when the at least one food item is within the heating cavity. Further still, the microwave oven comprises a means for cycling the radiant heat on for finishing of the at least one food item when the at least one food item is received in the heating cavity and for cycling the heat off when the finishing is not being performed.

Yet still another example of the invention relates to a method of heating an item. The method comprises providing the item in a heating compartment and heating the item using microwave radiation. The method also includes heating the item using radiant energy provided to the item by a high-intensity resistive ribbon heating element.

Alternative examples and other exemplary embodiments relate to other features and combinations of features as may be generally recited in the claims;

### BRIEF DESCRIPTION OF THE DRAWINGS

The invention will become more fully understood from the following detailed description, taken in conjunction with the accompanying drawings, wherein like referenced numerals refer to like elements, in which:

FIG. 1 is a perspective view of a microwave oven including a resistive-ribbon heating device;

FIG. 2 is an exemplary depiction of the resistive ribbon heating element disposed within the oven housing.

### DETAILED DESCRIPTION OF EXEMPLARY EMBODIMENTS

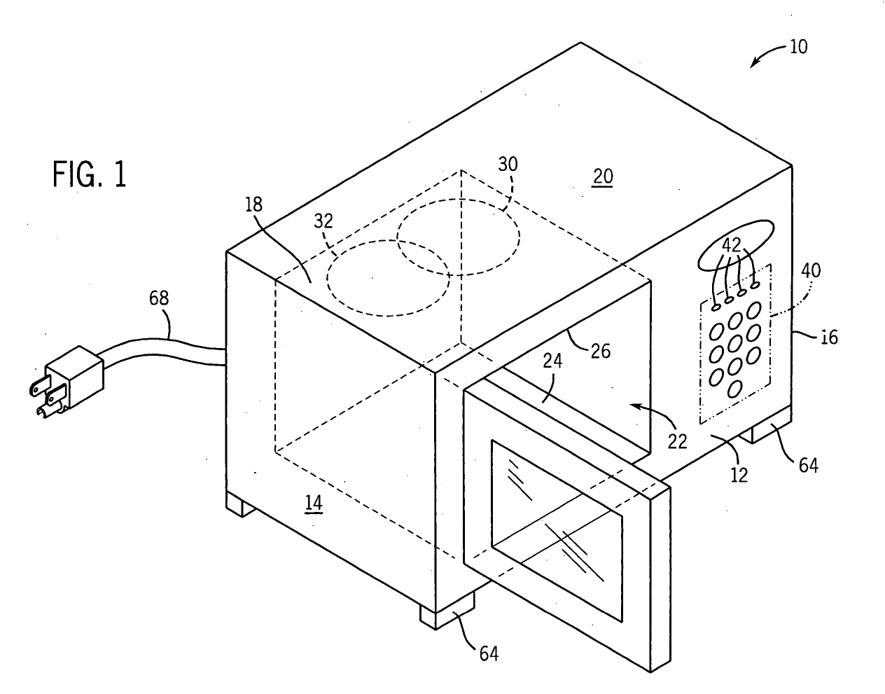

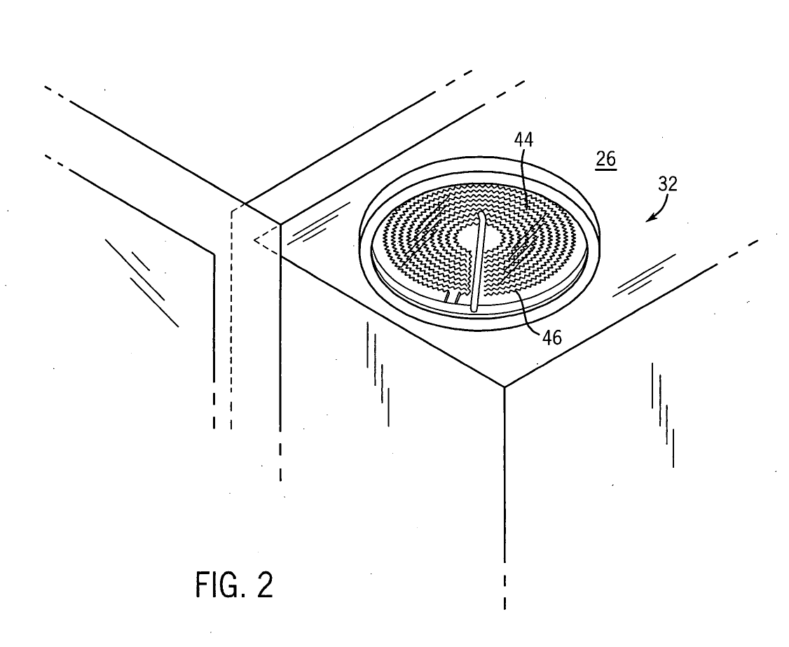

Shown in FIGS. 1-2 is a microwave oven device 10 with infrared heating capabilities according to an exemplary embodiment. Microwave oven 10 may advantageously be used to reduce cooking times of food products and liquids as compared to conventional or convection heating ovens, while still providing infrared heating capabilities to aid in the browning and moisture reduction in many cooking applications.

Oven device 10 according to an exemplary embodiment includes an oven housing comprised of a base 12, left and right side walls 14 and 16 attached to and extending upward from the left and right edges of base 12, a rear wall 18 attached to and extending upward from the rear edge of base 12 between side walls 14 and 16, and a top 20 attached to left and right side walls 14 and 16 and rear wall 18 opposite base 12.

Base 12, left and right side walls 14 and 16, rear wall 18 and top 20 together define a cavity 22 having a bottom portion 24 and a top portion 26. Bottom portion 24 is disposed above and adjacent to base 12 and is configured to support a food product placed within cavity 22. A carousel may be provided on bottom portion 24 to support and rotate food product while cooking in cavity 22.

Oven device 10 further includes microwave unit 30 and heating unit 32. Microwave unit 30 may have several different known configurations to provide heating to food product in cavity 22 with microwave energy as is well known in the art. According to an exemplary embodiment, microwave unit 30 includes a magnetron tube, a waveguide and a stirrer blade to apply microwave energy, microwave radiation, or microwaves to food product.

As described further below, control unit 40 has the capability of independently controlling the operation of units 30 and 32 through the use of one or more microprocessor-controlled heating sequences that are preprogrammed, timed or preset to meet the heating needs of a user, particular types of food items, etc. In one embodiment, control unit 40 can be programmed to run one of four different or more predetermined heating sequences via activation of a corresponding one of four different or more push-button switches 42 by a user, with each heating sequence capable of independently varying the cycle times and power levels of both units 30 and 32. Push-buttons 42 can thus be used to activate the proper heating sequence for each of five different or more food types with varying requirements. According to another exemplary embodiment, control unit 40 can be programmed to control units 30 and 32 for predetermined, timed periods or user specified time periods.

Heating unit 32 may comprise a metal box or housing sized to fit within top portion 26 of cavity 22 so that heating unit 32 can be securely attached within oven device 10 by, for example, welding or fasteners (e.g., screws, rivets). Referring specifically to FIG. 2, the top surface of heating unit 32 is formed of a glass panel 44. Glass panel 44 are attached to the edges of the housing of heating unit 32. One or more electrically-powered heating elements 46 are mounted in heating unit 32. Heating element 46 is adapted to focus radiant energy into cavity 22 through glass panel 44. Heating element 46 receives a flow of electricity under the control of a control board mounted within control unit 40.

When food items are placed within cavity 22, heat generated by heating element 46 is directed or focused toward those food items from above the food items. The heat from heating unit 32 performs the dual functions of heating the food product itself, and browning or melting the top of the food product.

Heating element 46 is preferably a resistive heating element which employ a thin, high-intensity resistive ribbon element which heats up to an orange glow almost instantaneously (e.g., in less than about 1.0 or 0.5 second). Heating element 46 can be, for example, Halient elements available from EGO North America. Alternatively, other types of heating elements can be used, such as elements which use a resistive wire coil. Preferably, the elements will be capable of being heated to their operating temperatures quickly, with the maximum allowed heating time depending on the application and the needs of the operator and/or food product.

A variety of size and number of heating elements may be provided within heating unit 32. For example, heating unit 32 may be a single Halient heating element having a nine (9) inch diameter and a power rating of 2500 W with a supply voltage of 240 Vac (EGO Part No. 10.53111.043), or may be one or more (e.g., an array) of Halient heating elements, such as multiple elements having six (6) inch diameters and power ratings of 1250 W with a supply voltage of 240 Vac. Heating elements having diameters of nine and six inches and power ratings of 2400 W and 1200 W, respectively, with a 208 Vac supply are also available. According to an alternative embodiment, geometrical arrangements of upper heating elements provide good heat coverage for cavity 22. The heating element described is also described in U.S. Pat. No. 6,262,396 which is herein incorporated by reference. Also a 120V-1000 W or 1200 W element are available.

Other types, sizes, numbers and geometrical arrangements of heating elements are possible depending upon the particular oven application, cavity shape, and on the size and shape of the serving plates regularly used in that application. Such alternative oven configurations will be readily apparent to those of skill in the art.

Glass panel 44 may be a clear glass panel which passes most of the radiant energy generated by heating element 46 to cavity 22 to heat any food items placed therein by the operator. In one embodiment, glass panel 44 is a tempax barosilicate glass panel made by Schott America of New York, sold under the SCHOTT glass tradename. The panel is formed of a clear, quartz glass that transmits or passes about 99% of the radiant energy. Other types of glass could also be used, including Ceran glass, although Ceran glass may not transmit radiation as efficiently as the Schott glass. In an alternative embodiment, a white Ceran glass, available from Schott, known by the tradename of White Arctic Fire, may be used.

As discussed above, the application of electrical power to heating element 46 in heating unit 32 is controlled by control unit 40. Unit 40 comprises a metal housing sized to fit within wall 16, such that unit 40 can be securely attached within oven device 10 using, for example, welding or fasteners (e.g., screws, rivets). Control unit 40 has a front surface 50 that provides an operator interface having a number of input devices (e.g., switches or buttons) for allowing the operator to control the operations of oven device 10, and a number of output devices (e.g., displays) for displaying status information to the operator.

Control unit 40 includes an electronic controller/output circuit board (not shown) mounted within its housing and an operator interface board 52 mounted to front surface 50. Operator interface board 52 is mounted such that the input devices (e.g., switches) on board 52 are accessible to the operator (e.g., through apertures in front surface 50), and such that the output devices (e.g., displays) on board 50 are visible to the operator (e.g., also via apertures in front surface 50). Of course, the input and output devices could also be mounted directly onto front surface 50. Control unit 40 provides programmable control of microwave unit 30 and heating unit 32 using timer circuits or a microprocessor-based controller. In one embodiment, control unit 40 provides the operator or food service worker with a plurality (e.g., five or more) of programmable sequences for independently operating heating element 46, with a corresponding plurality (e.g., four or more) of push-buttons provided to allow for one-touch control for each sequence. According to an alternative embodiment, one or more touch buttons may be provided to activate the heating element for a discrete amount of time independent of the microwave unit.

Each sequence can be programmed for a different type of food item, thereby allowing the operator to select one of the plurality (e.g., four) of predetermined sequences simply by pushing a push-button. For example, oven device 10 could be configured or programmed such that one push-button triggers a first preset sequence for operating microwave unit 30 and heating element 46 in a first manner suitable for preparation and/or finishing of a first food product, a second push-button triggers a second present sequence for operating unit 30 and element 46 in a second manner suitable for preparation and/or finishing of a second food product, etc. In this way, oven device 10 can be programmed to provide a simple operator interface to accurately control the heating of many food items.

The electronic controller/output circuit board mounted within control unit 40 includes voltage output circuits, a timer circuit and an annunciator (e.g., a buzzer circuit). The line voltage output circuit includes a load-carrying triac. Triacs are solid-state switches capable of reliably handing a large number (e.g., hundreds of thousands) of power cycles without failure. For oven device 10, the controller/output circuit board receives two voltage inputs including a 12-24 V input voltage, and a 110-240 V.sub.AC line voltage input, and then generates voltage outputs including a line voltage output for heating element. The triac has the capability to handle a 12 A resistive load.

The timer circuit on the controller/output circuit board operates the triacs semi-independently to control the supply of line voltages applied to heating element 46. In one embodiment, the timer circuit is a programmable timer configured to run from 0 to 30 min. in minute and second increments. Preferably, the timer circuit includes a microprocessor circuit configured (i.e., programmed) to perform the various functions described below. As noted, the timer circuit provides a plurality (i.e., five or more) of programmable sequences for operating the upper and lower heating elements, with each “run-time” sequence being triggered by the edge signal from one of the five program switches 58a-58e. In the microprocessor embodiment of the timer circuit, the microprocessor stores five different programs, each used for a different type of food item. Each program allows the user to select the on-time, off-time and amount of power to be applied to the food items by heating element 46 and microwave unit 30. By managing heating element 46, food items can be heated quickly without being burned. These sequences are further described as follows:

Run-Time Sequence: heating element 46 has five or more separately programmable timing sequences and 10 selectable power levels. The particular values for the timing sequences and selectable power levels used for the final finishing (e.g., browning, melting) of a particular food item may be determined via empirical testing.

Timing Sequences: The time values heating element 46 represent the “on” times and the time value for heating element 46 may be any value between 0 and 30 minutes.

Selectable Power Levels: The power levels of heating element 46 may be selected by varying the duty cycle of the on time. For example, it may be possible to configure a system in which a 10% power level is achieved by cycling on for 4 seconds and off for 36 seconds, 20% power level is achieved using 4 seconds on and 16 seconds off, 30% power level is achieved using 4 seconds on and 9 seconds off, 40% power level is achieved using 4 seconds on and 6 seconds off, 50% power level is achieved using 4 seconds on and 4 seconds off, 60% power level is achieved using 6 seconds on and 4 seconds off, 70% power level is achieved using 9 seconds on and 4 seconds off, 80% power level is achieved using 10 seconds on and 2.5 seconds off, 90% power level is achieved using 18 seconds on and 2 seconds off, and 100% power level is achieved by remaining heating element 46 continuously on.

A number of components may be mounted external to oven device 10. The external components include a plurality (i.e., four) of rubber or plastic supports 64 attached to the four corners of base 12 to provide support for oven device 10 on a support surface (not shown).

An electrical power cord 68 passes through a grommet into the interior of control unit 40 to provide the electrical energy needed to run oven device 10. To provide a cooling air flow to the interior components of control unit 40, the rear surface of control unit 40 can be provided with louvers, and a cooling fan can also be mounted on that rear surface to blow cooling air into control unit 40.

Thus, oven device 10 is capable of rapidly melting or browning the top surface of food items or meals. The Halient heating elements used by oven device 10 may preferably reach operating temperatures within a few seconds (e.g., about 1-3 seconds from room temperature).

In operation, use of microwave unit 30 advantageously reduces cooking time over a conventional or convection oven by some 30-50%. Heating unit 32 assists in further reducing cooking time and aiding in moisture reduction and browning. As compared to other oven units which may employ a browning element having a metal sheathed or quartz tube element, heating unit 32 requires has minimal warm up time to be in condition for use. Heating unit 32 generates radiant heat through glass panel 44 onto the food in the cooking or retherming cavity 22. Heating element 46 is a rapidly heating, high intensity heating element capable of being rapidly cycled. Heating element 46 is protected from spattering of food debris and moisture by glass panel 42.

Positioning of the heating element 46 is important because the radiant energy needs to be applied uniformly on the product. According to a particularly preferred embodiment, the carousel is used to allow for off-center positioning of element 46, still allowing for uniform application of radiant heat to the food product and also preventing over-heating of the center portion of the product being cooked.

In many food products, especially those which contain bread or other dough products, microwave energy alone degrades the product, breaking down the structure of the dough in such a way as to make it “soggy” or “chewy”. By adding the infrared energy, that degradation is greatly removed while the speed of cooking or rethermalization is still considerably shorter than other conventional methods.

Since the microwave energy penetrates fairly deeply into the product being cooked and the IR supplies very short wave energy with little penetration, but very high browning characteristics, the combination improves the appearance and quality over both the microwave only and the combination microwave-convection unit.

It should be understood that these embodiments shown in the FIGS. and described above are offered by way of example only. The invention is not intended to be limited to any particular embodiment, but is intended to extend to various modifications that nevertheless fall within the scope of the appended claims. For example, different configurations of the oven can be used, such as having infrared heating elements at locations besides directly above the food item. The types, sizes, numbers and geometrical arrangements of the heating elements can be modified depending on the application of the oven device. The type of control unit can be changed, and different types and numbers of programmable or non-programmable timers can be used. Other modifications will be evident to those of skill in the art.

1. A microwave oven device for heating at least one food item, the oven device comprising:
an oven housing defining a heating cavity therein, the heating cavity receives the at least one food item to be heated by the oven device;
a microwave energy source for heating the at least one food item with microwave energy; and
a heating unit disposed within the oven housing the heating unit comprising a heating element, the heating element generating radiant heat which is directed toward the at least one food item received in the heating cavity, the heating element comprising a rapidly-heating, high-intensity resistive ribbon heating element capable of being cycled on for final finishing of the at least one food item when the at least one food item is received in the heating cavity, and capable of being cycled off when such final finishing is not being performed, the resistive ribbon heating element configured to provide radiant energy directly to the food item.

2. The microwave oven device of claim 1 wherein the final finishing of the at least one food item includes browning a top surface of the at least one food item.

3. The microwave oven device of claim 1 wherein the final finishing of the at least one food item includes melting a topping placed on a top surface of the at least one food item.

4. The microwave oven device of claim 1 wherein the oven housing comprises a base, two side walls extending upward from the base, and a top supported by the two side walls, the base, two side walls and top surrounding the heating cavity.

5. The microwave oven device of claim 1 wherein the oven housing further includes a rear wall extending upward from the base at the rear of the oven device.

6. The microwave oven device of claim 1 wherein the heating element comprises a Halient heating element.

7. The microwave oven device of claim 1 wherein the heating element can be heated to an operating temperature within a time period on the order of seconds.

8. The microwave oven device of claim 1 wherein the heating unit includes a heating unit housing having a surface formed by a glass panel, and the radiant heat generated by the heating unit is directed through the glass panel into the heating cavity.

9. The microwave oven device of claim 8 wherein the glass panel comprises a clear, quartz glass or a Ceran glass panel that allows transmission of the radiant energy generated by the heating unit into the heating cavity.

10. The microwave oven device of claim 9 wherein the glass panel is formed of a SCHOTT glass panel capable of transmitting substantially all of the radiant energy generated by the heating unit into the heating cavity.

11. The microwave oven device of claim 11 further comprising a carousel disposed within the heating cavity, the rack being configured to support and rotate the at least one food item.

12. The microwave oven device of claim 1 further comprising a control unit coupled to the heating unit and the microwave energy source, the control unit being programmable to control the heating unit and the microwave energy source according to a preprogrammed heating sequence.

13. The microwave oven device of claim 12 wherein the preprogrammed heating sequence includes control data for both the timing and power level of the heating unit.

14. A microwave oven device for cooking a food item, comprising:
a heating cavity configured to receive the food item;
a microwave unit configured to provide microwave energy to the food item;
a heating unit disposed above the heating cavity, the heating unit comprising a heating element, the heating unit generating radiant heat which is directed onto the food item when the food item is received in the heating cavity, the heating element each including a rapidly-heating, high-intensity resistive ribbon heating element, the resistive ribbon heating element providing radiant energy directly to the food item.

15. The microwave oven device of claim 14 wherein the heating unit includes a heating unit housing having a surface formed by a glass panel adjacent to the heating cavity, and the radiant heat generated by the heating unit is directed through the glass panel into the heating cavity.

16. The microwave oven device of claim 14 further comprising a control unit coupled to the microwave unit and the heating unit, the control unit being programmable to control the microwave unit and the heating unit according to a preprogrammed heating sequence.

17. The microwave oven device of claim 16 wherein the preprogrammed heating sequence includes control data for both the timing and power level of the heating unit

18. The microwave oven device of claim 17 wherein the preprogrammed heating sequence includes control data for both the timing and power level of both the microwave unit and the heating unit.

19. A microwave oven for cooking a food item, comprising:
an oven housing means for defining a heating cavity for receiving the food item;
a means for providing microwave energy to the food item;
a resistive ribbon heating means within the oven housing means for generating high-intensity radiant heat and for directing the heat directly onto a top surface of the food item when the at least one food item is within the heating cavity; and
a means for cycling the radiant heat on for finishing of the at least one food item when the at least one food item is received within the heating cavity and for cycling the heat off when the finishing is not being performed.

20. The microwave oven of claim 19 further comprising means for rotating the food item.

21. A method of heating an item, comprising:
providing the item in a heating compartment;
heating the item using microwave radiation; and
heating the item using radiant energy provided to the item by a high-intensity resistive ribbon heating element.
